(19) United States
(12) Patent Application Publication
(10) Pub. No.: US 2007/0008138 A1
(43) Pub. Date: Jan. 11, 2007

(54) COORDINATED IDENTIFICATION OF PERSONS AND/OR ARTICLES VIA RADIO FREQUENCY IDENTIFICATION CROSS-IDENTIFICATION

(75) Inventors: Walter W. Mosher JR., West Hills, CA (US); Oswaldo Penuela, Santa Clarita, CA (US); Robert Fleet, Montclair, CA (US)

Correspondence Address: KELLY LOWRY & KELLEY, LLP, 6320 CANOGA AVENUE, SUITE 1650, WOODLAND HILLS, CA, 91367, US

(73) Assignee: PRECISION DYNAMICS CORPORATION, San Fernando, CA (US)

(21) Appl. No.: 11/161,001

(22) Filed: Jul. 19, 2005

Related U.S. Application Data
(60) Provisional application No. 60/590,026, filed on Jul. 20, 2004.

(51) Int. Cl. G08B 13/14

(52) U.S. Cl. 340/572.4

(57) ABSTRACT

A process and system for identifying and tracking persons and related articles, includes the steps of registering a person and one or more articles in a coordinated relationship, storing information concerning the person, the articles and the coordinated relationship in a database, cross-referencing RFID tags with the information stored in the database, attaching the cross-referenced RFID tags to the person and at least one of the articles, reading the RFID tags at random intervals, and enabling an alarm if the RFID tags do not match the cross-referenced information stored in the database. The invention also includes a system for performing this inventive process. The process may be adapted to various situations, a particularly preferred embodiment is adapted to the transportation industry.

### BACKGROUND OF THE INVENTION

Passenger identification, passenger reservation and baggage tracking systems are known in the art. Travelers typically purchase a ticket in advance, the ticket is recorded in a reservation database and, when the passenger arrives with his baggage, he presents his ticket and a form of identification which, when confirmed by the reservation system, allows him to be issued a boarding pass to the vehicle. His checked baggage is tagged and sent onto the vehicle separately by transportation company personnel.

Security matters involving both criminal and terrorist issues have upped the scale of concern for a pro-active cross-identification system dedicated to the logistics of a transportation management system, especially since the 9/11 tragedy proved how vulnerable transportation management systems are to self-destructive acts of violence. To address such concerns, radio frequency identification (RFID) technology provides a relatively inexpensive, high technology set of solutions.

Properly configured, an RFID-based system creates a unique set of personalized, transportable and inexpensive communications appliances that can be encoded with personal identification data and linked to a sophisticated database system that allows cross-referential identifications of a passenger and his baggage all along this travel through a transportation byway. One such system for item management via an electronic communication network is addressed in Hardgrave (U.S. Pat. No. 6,662,078), which utilizes RFID tags for tracking baggage. But, in fact, Hardgrave's system is limited to baggage tracking and tags alone and employs only minimal cross-referencing checkpoints. Likewise, a baggage system security system is envisioned by Quakenbush (US 2003/0100973), but limits major focus of interest to utilizing the internet for tracking baggage.

Davis (US 2003/0093305) introduces RFID technology to the passenger check-in process, the limitation of his process being its reliance upon fixture checkpoints and is essentially inflexible in that regard.

Burkhardt (US 2003/0128100) develops a system for monitoring individuals and associated objects with wireless identification tags. In its definition of the system, however, Burkhardt's embodiments concentrate upon the working of the components and do not address the methodology of tracking with a specific purpose or logistical needs in mind. This is the same limitation of Kreiner's (US 2004/0084525) system for monitoring and tracking objects. Both inventions, while employing the concept of “system” in the technical sense, would become components of a larger transportation management system.

Tuttle (U.S. Pat. No. 6,127,917; U.S. Pat. No. 6,509,829; US 2003/0122685) discloses an RFID card-based system in which travel reservations are cross-referenced to passenger flight information, with the intention of being able to locate the passenger and his baggage anywhere within a transportation depot. The limitation is that it is card-based, a medium where transfer from person-to-person is easily accomplished. Tuttle is focused on resolving reservation issues and logistics-related transportation issues and does not offer solutions for security concerns.

### SUMMARY OF THE INVENTION

The present invention relates to a system and process for identifying and tracking persons and articles having a coordinated relationship to one another. More specifically, the present invention relates to a system and process for identifying and tracking passengers and baggage in relation to a transportation vehicle.

An advantage of the present invention over the prior art discussed above begins with its emphasis on non-transferability in the RFID data-carrying media itself. Once issued, the RFID media stays with the person and/or articles or the system sets off an alarm either automatically or following a reading step as described below, and the person and articles are isolated until the problem is resolved.

Another major advantage of the present invention over the prior art is its flexibility: there are fixed and random checkpoints for cross-identification within the system—and even many of the fixed checkpoints (e.g., passengers loading onto a vehicle) can be flexibly located via handheld RFID reading units operated by operation personnel.

The present invention is flexible in its technology as well: it is configured to work with minimal use of RFID technology—or expand to full implementation. It is able to accomplish this flexibility by its recognition of the human factor and existing elements of applicable systems, i.e., a transportation management system, including but not limited to ticketing points, passenger/baggage terminals, vehicles and the passengers and personnel engaged in the system. The present invention is designed to complement existing systems and utilize personnel within the context of their current participation profiles.

An important advantage of the present invention over its predecessors is its orientation and emphasis on security concerns in existing systems. At each stage of the person/article flow, the present invention provides the possibility for an RFID-enabled alarm or alert solution pathway.

An object of the present invention is to provide an RFID-based security system for the cross identification of persons with related articles in a coordinated relationship.

Another object of the invention is to provide an RFID-based security system for the cross-identification of passengers with their baggage in a coordinated relationship to the transportation vehicle(s) on which they are scheduled to travel. The system may employ active, semi-active or passive radio frequency identification technology. The system may be configured to allow for backward compatibility with existing barcode and other existing electronic technologies.

The system includes passenger/baggage-linked RFID devices that are coordinated with a travel management system linked to the passenger's scheduled vehicle(s). Unauthorized removal of one or more of the RFID devices will trigger an alarm; the absence or dislocation of one or more of the RFID devices will trigger an alarm; misidentification of an RFID device with its attached passenger and/or baggage will trigger an alarm.

The system may be configured to cross-identify individual passengers to an assigned sub-group of passengers within a vehicle's passenger list. The sub-grouping may include non-nationals on the flight list, passengers-to-tour group, child-to-parent, pet-to-owner, students-to-teacher and the like. Separation from the sub-group, or misidentification with a sub-group, will trigger an alarm.

The RFID device consists of attachable and tamper-resistant banding and/or tagging identification appliances such as wristbands, stickers, tags or other appliances, or combinations of different appliances. The RFID device may also include printed indicia for visual references and/or backward compatibility with existing components in the transportation management system.

Security features may also include:

One or more of the RFID devices employs a biometric sensor capable of obtaining cross-referencing information about the passenger.

A fastener on the identification appliance indicates whether the appliance has been attached to a wearer or baggage and if so, enables circuit functions; if tampered with, the circuit functions may be disabled, certain data erased, and/or evidence of tampering made apparent.

Photographic imagery of the passenger wearing an identification appliance; the image may be encoded into the passenger's RFID device(s) or be an encoded trigger to the system at large, which can maintain a database of passenger photographs for cross-identification and other security and/or commercial purposes.

System links with national identity, national security or law enforcement agencies and/or their databases.

The ultimate goal of the system is to monitor the location and the identity of persons and related articles. More specifically, the system can monitor the location and identity of passengers and their baggage on an airplane, train, boat, bus, or other vehicle.

The system and its associated RFID device(s) may be employed as the passenger ticket and baggage tag(s).

The identification band may contain a person's national identification status, for use in transportation terminal security and national security purposes.

Additional objects and advantages of the invention will be set forth in part in the drawings which follow, and in part will be obvious from the description, or may be learned by practice of the invention. It is to be understood that both the foregoing general description and the following drawings are exemplary and explanatory only and are not restrictive of the invention as to be claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a flow chart representing the basic embodiment of the invention's system and methodology.

FIG. 2 is a flow chart representing an alternate embodiment of the invention's system and methodology, specifically tailored to the transportation industry.

FIG. 2A is a continuation of the flow chart of FIG. 2.

FIG. 3 is a pictorial view of the first checkpoint for security check. The cross-identifications are: visual review of the Passenger, visual review of the passenger's government-issued Identification Document, and accessing the transportation management system database to confirm the passenger's physical Ticket (or electronic Ticket) Reservation. Upon correct matching of all three elements, the Passenger's ID, ticket and baggage data are input/updated in the transportation management system database

FIG. 4 is a pictorial view of the updating of the transportation management system database and issuing of cross-referenced RFID appliances—bands and tags—to be affixed to the Passenger, his Baggage and his Ticket.

FIG. 5 is a pictorial view of the cross-identification matrix established among the Passenger, his Baggage, the Vehicle and the transportation management system Database.

FIG. 6 is a flow chart representing another alternate embodiment of the invention's system and methodology, specifically tailored to the transportation industry, with manual entry of data as passengers/articles enter the system.

FIG. 7 is a flow chart representing another alternate embodiment of the invention's system and methodology, in which input of the passenger's government-issued identification document is electronically entered and monitored for validity.

FIG. 8 is a flow chart representing another alternate embodiment of the invention's system and methodology, building upon the embodiment in FIG. 7, in which the transportation management system database is linked to a national or international identification database.

FIG. 9 is a diagram of one embodiment radio frequency identification appliance: a band with an affixed RFID inlet.

FIG. 10 is a cutaway diagram of one embodiment of an RFID appliance: a band, tag or label in which the RFID inlet is permanently affixed within the layers of the appliance.

FIG. 11 is a side view of one embodiment of an RFID appliance: a label which is affixed by means of an adhesive to the surface of a band, baggage or ticket.

FIG. 12 is diagram of one embodiment of an RFID appliance, a tag with an RFID inlet, attached to a band; said band can be attached to a passenger or the passenger's baggage.

FIG. 13 is a pictorial view of an RFID appliance consisting of an RFID tag attached to a band and the band attached to a passenger's wrist. Note that printed indicia may also be applied to the RFID tag.

FIG. 14 is a pictorial view of the cross-identification relationships among the RFID appliance on a passenger's wristband, the RFID appliances on the passenger's baggage, and the passenger information called up from the database when the encoded data in the RFID appliances are accessed.

FIG. 15 is a diagram of one embodiment of an RFID appliance: a set of adhesive-backed plastic or reinforced paper band and labels or tags—each containing an RFID inlet—that can be encoded in one sheet and affixed to the passenger, passenger's ticket and passenger's baggage. This embodiment can also be configured to allow printed indicia for visual referencing.

FIG. 16 is a diagram of an embodiment of an RFID appliance where there is an RFID inlet affixed and printed indicia for ticket information.

### DETAILED DESCRIPTION OF THE PREFERRED EMBODIMENT

The present invention relates to a system and process for identifying and tracking persons and articles having a coordinated relationship to one another. More specifically, the present invention relates to a system and process for identifying and tracking passengers and baggage in relation to a transportation vehicle.

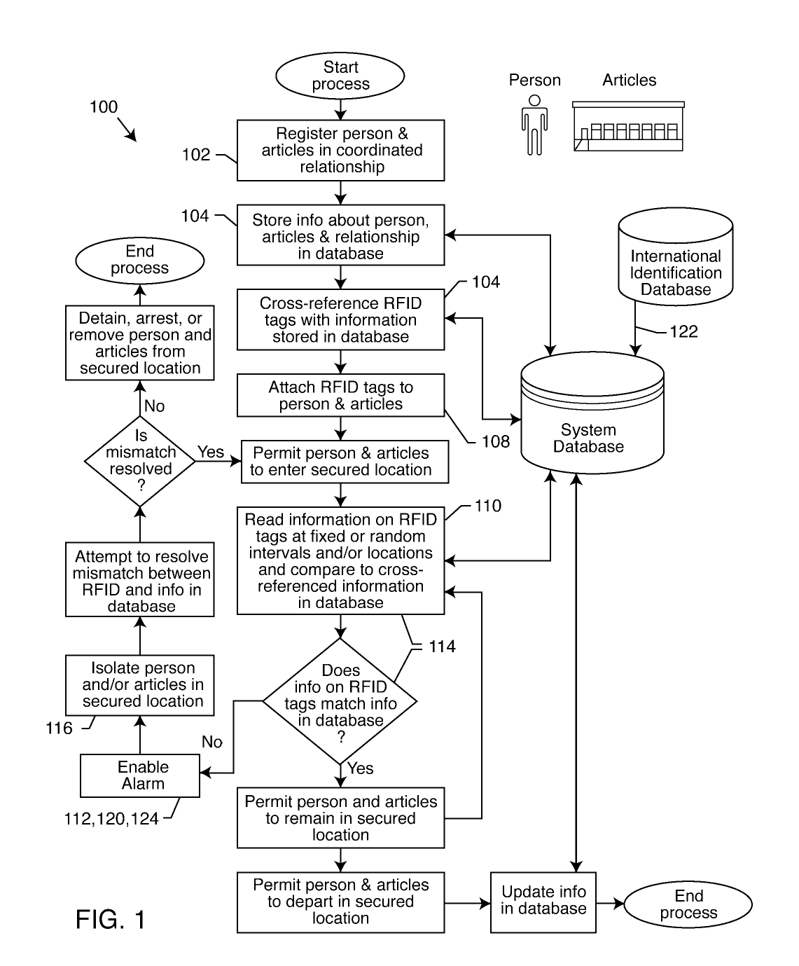

The most basic embodiment of the present invention, as shown in FIG. 1, is a process for identifying and tracking related persons and articles (100) comprising the following steps:

registering a person and one or more articles in a coordinated relationship (102);

storing information concerning the person, the articles and the coordinated relationship in a database (104);

cross-referencing RFID tags with the information stored in the database (106);

attaching the cross-referenced RFID tags to the person and at least one of the articles (108);

reading the RFID tags at random intervals (110); and

enabling an alarm if the RFID tags do not match the cross-referenced information stored in the database (112).

This inventive process (100) is broadly applicable to any setting in which it would be desirable to track persons and articles in a coordinated relationship, including but not limited to, transportation terminals, entertainment venues, government buildings, etc. The primary purpose of the present invention is to facilitate reliable and secure identification and tracking of persons and articles in locations where safety and security are a concern. The present invention will allow security personnel to know which articles belong to which persons and whether or not an article has been abandoned or even belongs in the secured location.

As represented in FIG. 1, upon entering a secured location a person along with one or more articles are registered with security or another monitoring department (102). The registration (102) creates a coordinated relationship between the person and the one or more articles in that person's possession. Security stores information concerning the person, the articles and the coordinated relationship in a database (104) that is accessible by other security or monitoring personnel at fixed and/or random points throughout the location (110). The database is preferably a computer stored and maintained database but may also comprise printed material that is supplemented periodically or whenever new information is added to the database.

Where the database is stored and maintained in a computer, the information may be input using existing or to be discovered computer technology including PC or Macintosh type computers or other existing system designed to receive data entry. In a preferred embodiment the information may be input using a dedicated input computer/device such as a CDU 500 or similar device.

RFID tags are cross-referenced with information stored in the database (106). Those RFID tags are then attached to the person and at least one of the articles (108). To maintain the security of the location, at fixed and/or random points throughout the location, personnel may read the information contained on the RFID tags either manually or using an RFID reader device (110). The information read from the RFID tags is then matched with the cross-referenced information stored in the database (114). If the information on the RFID tags does not match the information stored in the database, then an alarm is enabled (112). This matching of the RFID tags to the cross-referenced information stored in the database (114) may be accomplished by cross-checking the RFID tags with the cross-referenced information stored in the database concerning the person, the articles and the coordinated relationship (114). If the RFID tags do not match the cross-referenced information and an alarm is enabled (112) and security personnel may isolate the person and the articles within the secured location or somewhere outside the secured location (116).

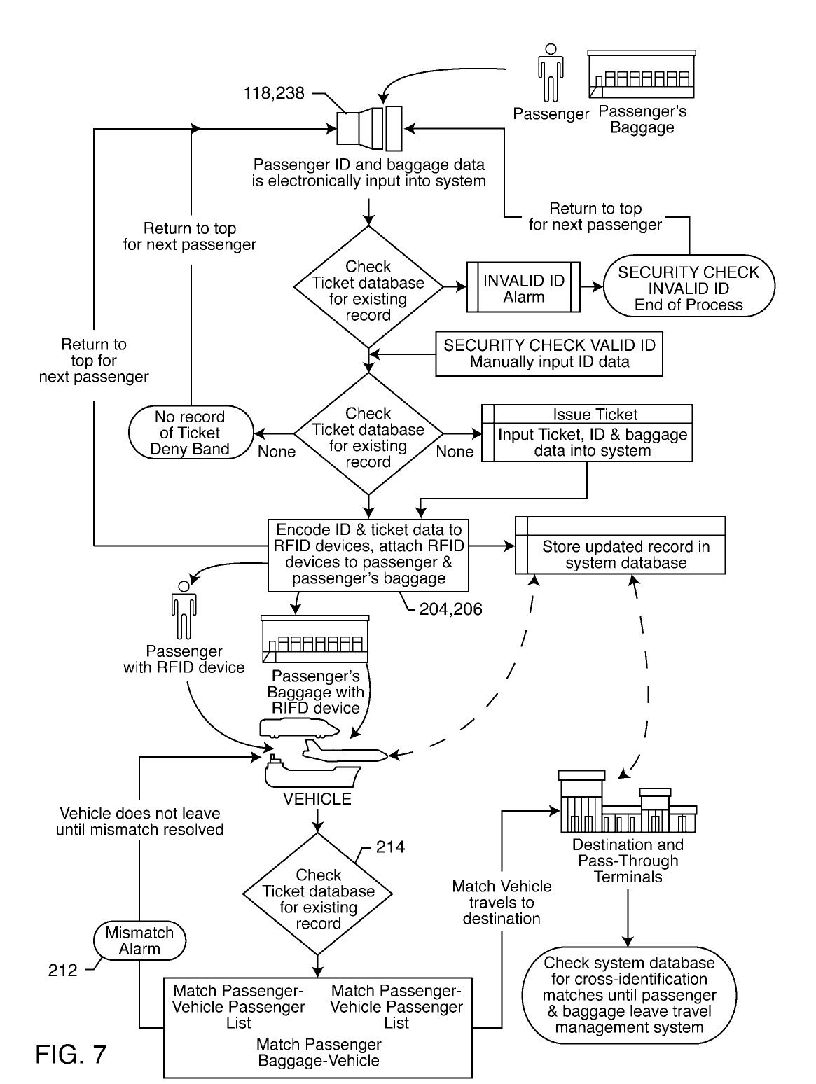

In alternate embodiments, the step of registering a person and one or more articles (102) may include inputting identification data about the person via electronic means (118) as shown in FIG. 7. These electronic means may include bar codes, magnetic stripes, RFID cards, biometric chips, photographic equipment, or sensors, i.e., environmental, biological, biometric and the like. In addition, the storing (104) cross-referencing (106) and cross-checking (114) steps may also utilize bar codes, magnetic stripes, biosensor or photographic equipment.

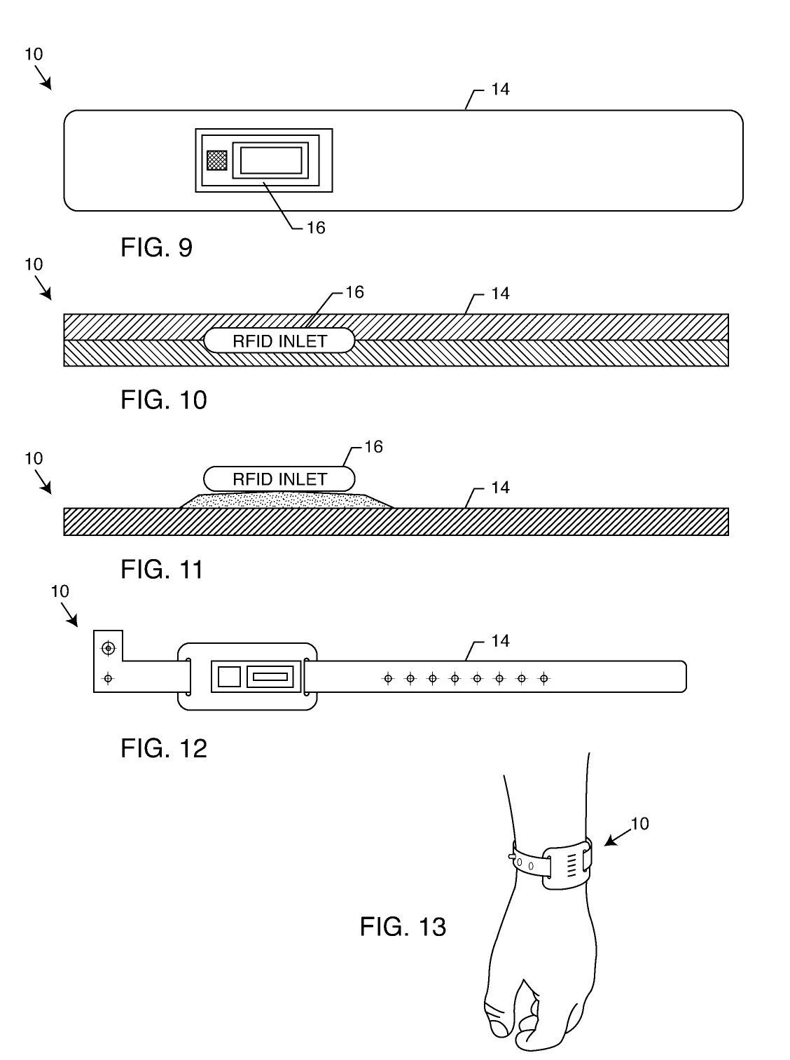

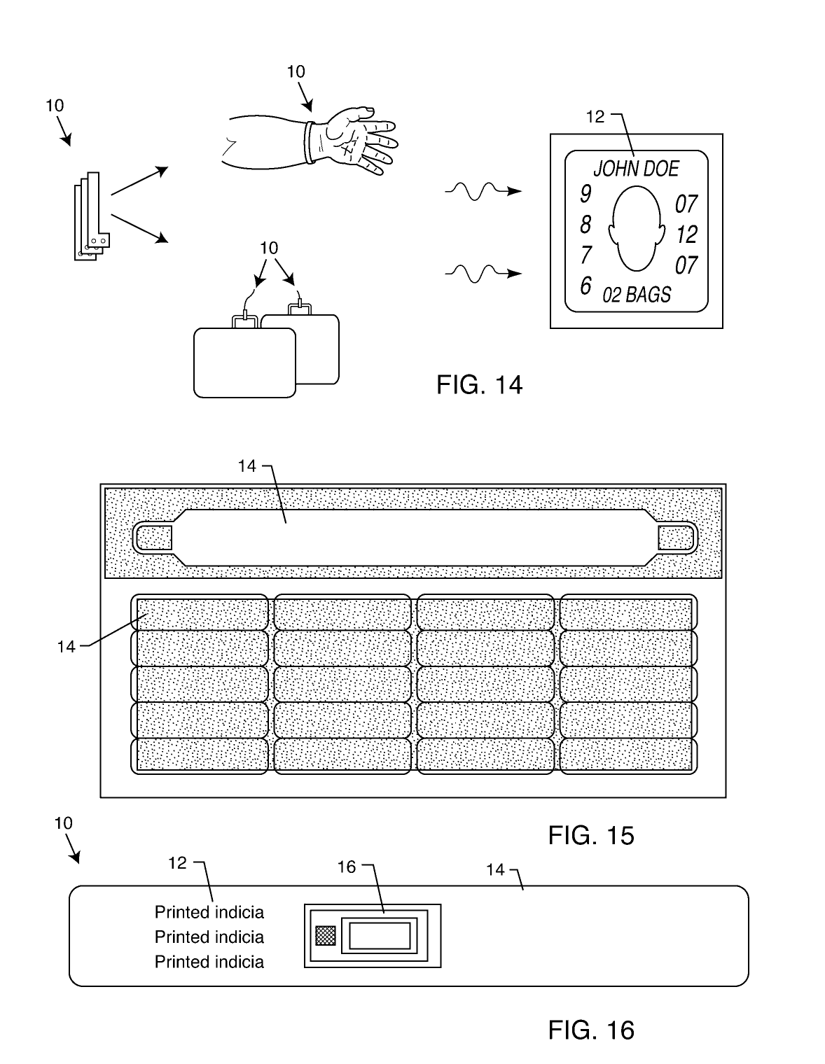

As shown in FIGS. 9-16, the RFID tags 10 may comprise wristbands, badges, stickers, labels, cards 14 or any combinations thereof including an RFID inlet 16. In addition, the RFID tags 10 are non-transferable and tamper resistant. The process may include the step of enabling an alarm if the RFID tags 10 are tampered with or removed from the person or articles (120). In addition, the RFID tags 10 may include printed indicia 12 corresponding to information about the person or article. The printed indicia 12 may include textual information, photographs, fingerprints or a bar code encoding any of the information collected about the person or articles. The system may use existing technologies to create a bar code symbol on the RFID tags 10 where one is used. The system may also employ an existing bar code on an admission ticket or other identification that the person is carrying. Thus, the system may use dual bar code and RFID reader technologies. The database storing information about the person, articles and coordinated relationship may be linked with national identity, national security, or law enforcement agency databases (122).

The coordinated relationship may also identify the person or articles with a group of persons. Such groups of persons may include non-nationals, tour groups, VIP guests, families, pet-to-owner, students-to-teacher or other groups. The process may further comprise the steps of enabling an alarm and/or isolating a person or articles if they are separated from the group with which they are cross-identified (124).

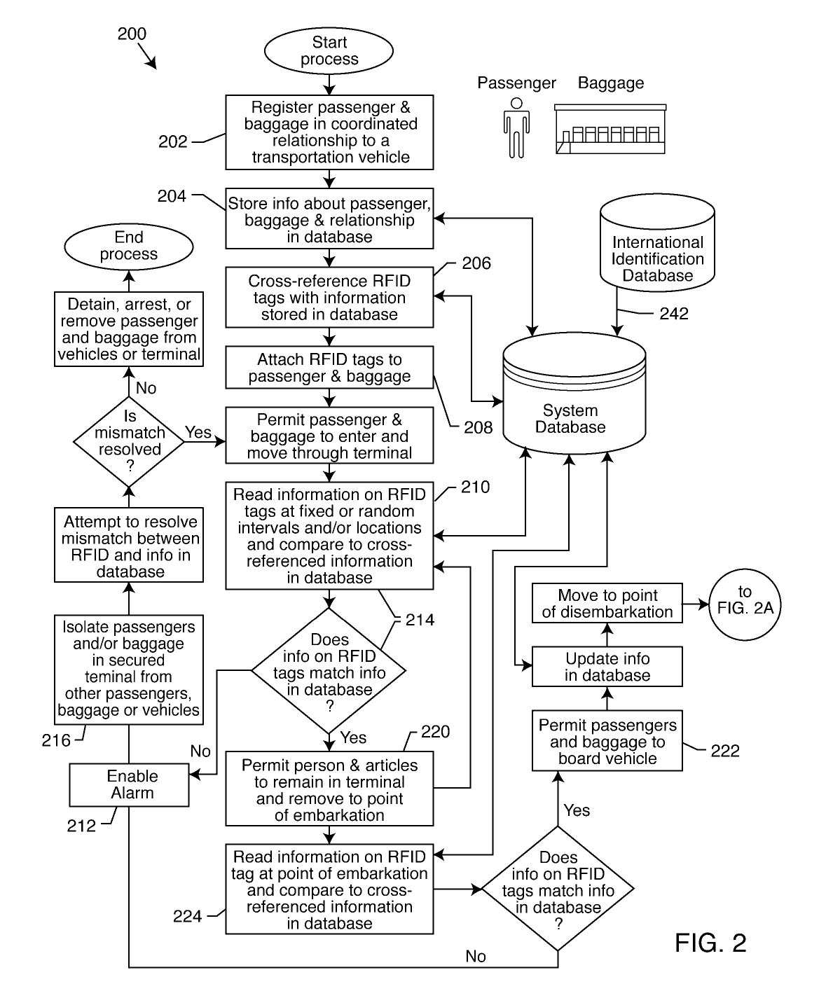

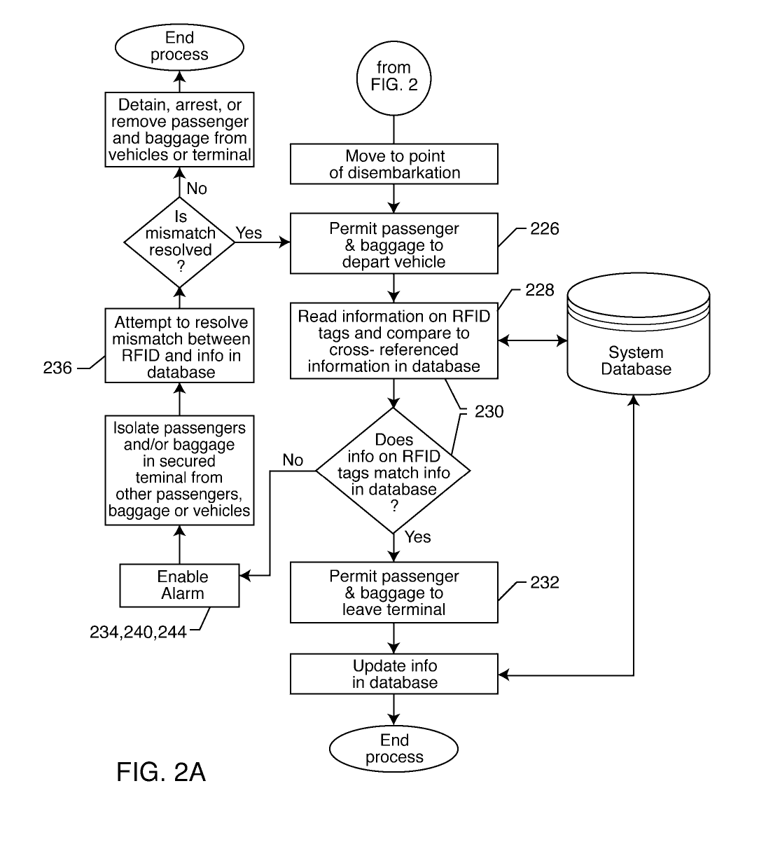

An alternate embodiment of the present invention, which is specifically tailored to the transportation industry and shown in FIGS. 2 and 2A, is a process for identifying and tracking passengers and baggage in relation to a transportation vehicle (200). This alternate embodiment follows the same basic structure as the previously described process. For purposes of illustration, the following description describes the inventive process with respect to an airport terminal, but is equally applicable to other types of transportation.

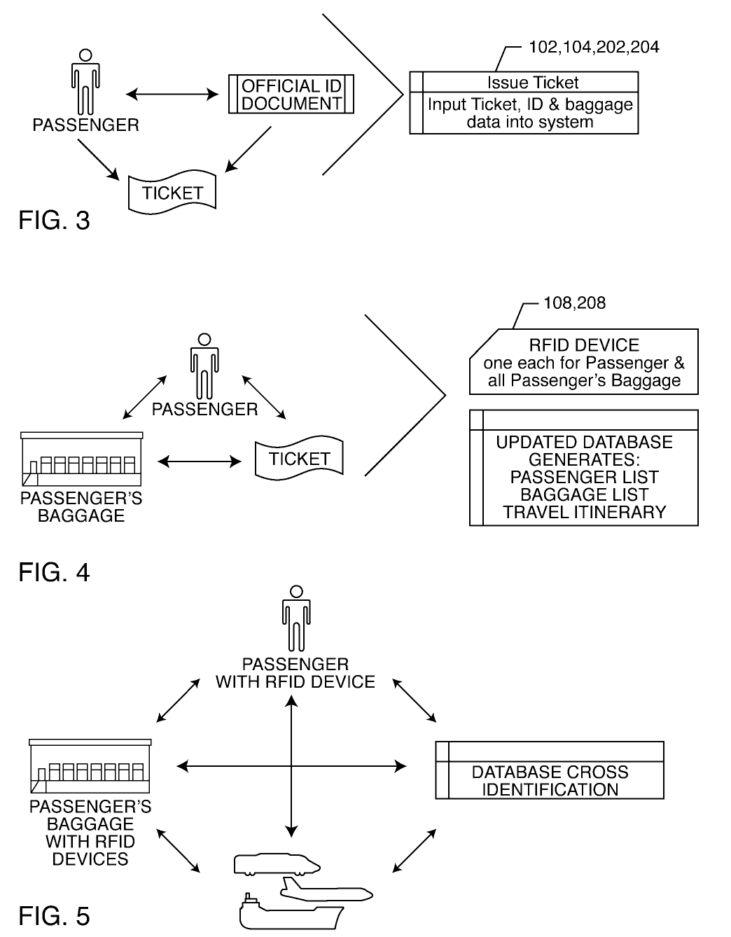

As shown in FIGS. 2-5, initially a passenger and one or more articles of baggage are registered in a coordinated relationship to a transportation vehicle (202). Information concerning the passenger, the articles of baggage, and the coordinated relationship to the transportation vehicle is stored in a database (204). This information may include identification document information, a physical description of the passenger and/or baggage and any other relevant information. Baggage will be subject to standard airport security scrutiny means outside the scope of this invention. As in the other embodiment, the database may be maintained on a computer or in hard copy format.

RFID tags are cross-referenced with the information stored in the database (206) and the RFID tags are attached to the passenger and at least one of the articles of baggage (208). At random intervals throughout a transportation terminal security personnel may read the RFID tags (210) and cross-check the RFID tags with the information stored in the database concerning the passenger, the articles of baggage, and the coordinated relationship to the transportation vehicle (214). If the RFID tags do not match the cross-referenced information stored in the database, an alarm sounds (212) and security personnel may isolate the passenger and/or the articles of baggage from the transportation vehicle, other passengers, other articles of baggage or the transportation terminal itself (216). Isolation will be maintained until any discrepancy can be resolved. Resolution may include reintroduction of passenger and/or baggage to transportation terminal, revision of database information, or detention/arrest of passenger.

In a transportation terminal the passenger and the articles of baggage may be moved through the terminal from the point of registration to a point of embarkation and loading (220). While moving through the transportation terminal, passengers and/or articles of baggage may pass through fixed security check points (210). In addition, the same passengers and articles of baggage may be subject to random security checks while in the transportation terminal (210).

At the point of embarkation, the passengers and articles of baggage are loaded onto a transportation vehicle (222). In the preferred embodiment, the RFID tags attached to the passenger and the articles of baggage may be checked again to confirm that only ticketed passengers and their related articles of baggage are allowed onto the vehicle (224). The process (200) also allows for personnel to confirm that if a passenger registers with an article of baggage that the related article of baggage is on the transportation vehicle with the passenger and not left in the transportation terminal or on another transportation vehicle with another passenger.

This embodiment also permits security personnel at another transportation terminal to identify and track passengers and baggage disembarking from a transportation vehicle (228). Once the transportation vehicle arrives at its destination terminal, the passengers and the articles of baggage are unloaded from the transportation vehicle at a point of disembarkation (226). At fixed and/or random intervals between the point of disembarkation and leaving the destination terminal, including the step of unloading the passengers and/or articles of baggage, the RFID tags may be read (228) and cross-checked with information stored in the database (230). In addition, airport personnel may check RFID tags in the baggage pick-up area to confirm the relationship between a passenger and an article of baggage and confirm that an article of baggage has left the terminal (232). Again, an alarm will sound (234) and the passenger and/or articles of baggage will be isolated from the transportation vehicle, other passengers, other articles of baggage or the destination terminal (236), if the RFID tags do not match the cross-referenced information stored in the database.

As with the other embodiment, the registering step (202) may include inputting identification data about the passenger and/or articles of baggage via electronic means (238). These electronic means may include bar codes, magnetic stripes, photographic equipment or biosensors. In addition, the storing, cross-referencing and cross-checking steps may also utilize bar codes, magnetic stripes, biosensor or photographic equipment.

The RFID tags 10 may comprise wristbands, stickers, labels, cards 14 or any combinations thereof including an RFID inlet 16. In the preferred embodiment the RFID tags are non-transferable and tamper resistant. If an RFID tag 10 is tampered with or removed from the person or articles of baggage, the process will enable an alarm (240) upon the next check by security personnel. The RFIF tags 10 may include printed indicia 12 corresponding to passenger and/or articles of baggage identification data or passenger travel itinerary information. The printed indicia 12 may include textual information, photographs, fingerprints or a bar code encoding any of the information collected about the passenger or baggage. The system (200) may use existing technologies to create a bar code symbol on the RFID tags where one is used. The system (200) may also employ an existing bar code on a travel ticket or other identification that the passenger is carrying. Thus, the system (200) may use dual bar code and RFID reader technologies. The database may be linked with national identity, national security, or law enforcement agency databases (242).

The process may also be configured to store information regarding a coordinated relationship between a passenger or articles of baggage and another group of passengers, i.e., non-nationals, VIPs, students, families, tour groups, or other groups of persons and/or articles traveling together. As in the other embodiment, the process will enable an alarm (244) if a passenger or articles of baggage are separated from the group of passengers with which they are cross-identified. The process may also isolate the passenger and/or articles of baggage that have been separated from the group of passengers with which they are cross-identified.

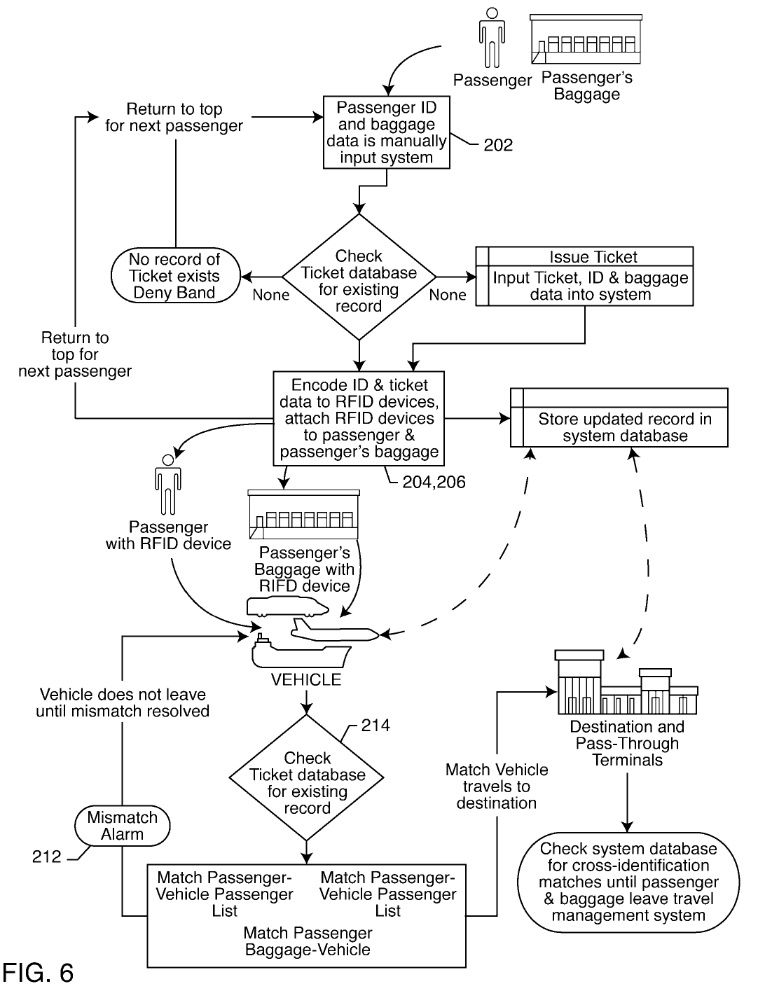

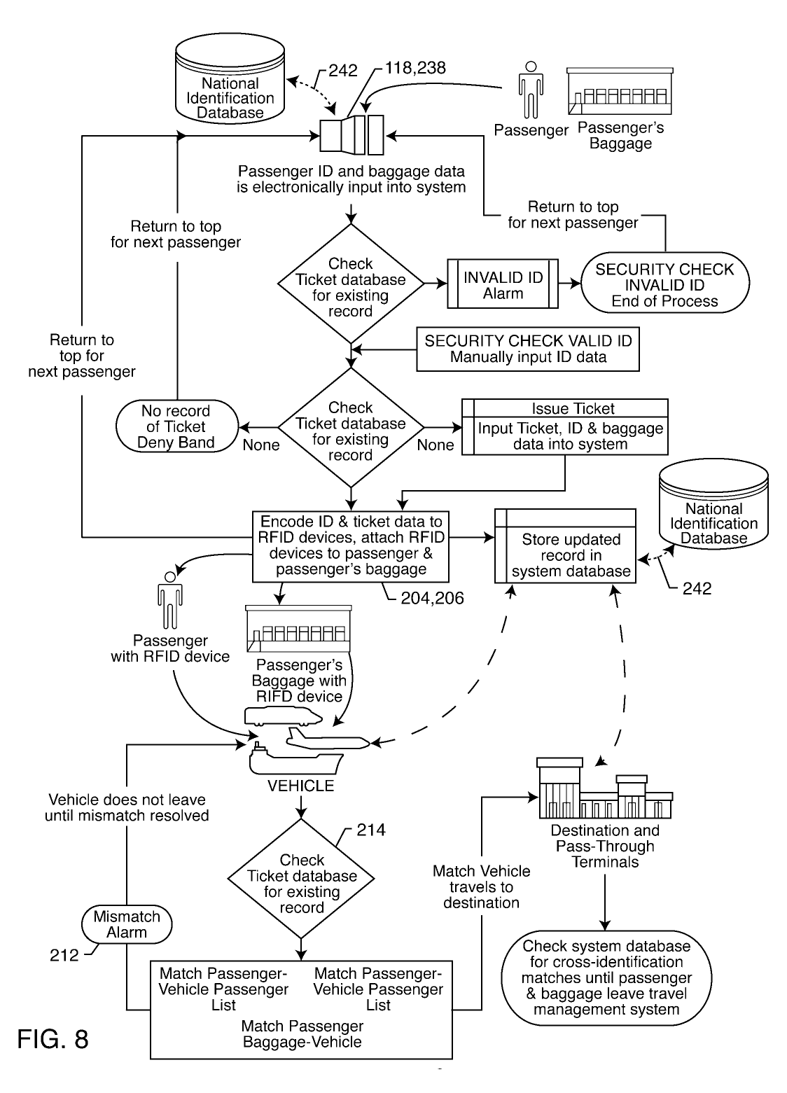

FIGS. 6, 7 and 8 depict an alternate travel management system for performing the inventive process comprising the following components:

an existing travel management system, including one or more transportation terminal locations for passenger/baggage/vehicle-processing, vehicles carrying passengers/baggage (airplane, ship, train, bus), ticketing/reservations database, and scheduled travel itineraries for the vehicles;

a ticketing system for passengers and their baggage (and/or other accompanying travel objects);

an electronic database in which the above information is stored, into which new information can be added, and is accessible by all parts of the travel management system;

radio frequency identification (RFID) read-and-write and read-only devices, permanent and/or portable, said devices connected electronically to the database;

RFID appliances that can be attached to passengers and their baggage/travel objects in a temporary, tamper-resistant and non-transferable manner; an RFID appliance is a wristband, sticker, label, card or any combination thereof to which a radio frequency-attuned electronic data-carrying chip-and-antenna (or comparable configuration) is embedded or affixed in such a way as to become a permanent fixture in the carrying media; the RFID inlet will have data read, read-write and transfer capabilities comparable to the state-of-the-art technology of the time and is not confined to current technological limitations; the RFID appliance may be configured to allow visible indicia printed thereon, corresponding to passenger and/or baggage identification data.

biosensor and/or photographic equipment in communication with the database and/or RFID devices.

personnel employed in the travel management system to operate and monitor the above components as they interact with passengers and passengers' baggage.

security personnel, working within the travel management system, who are trained to resolve identification issues of a potentially dangerous nature.

A connection to national and/or international identity and/or security databases.

Concerning improved passenger traffic flow and U.S. national security interests, as discussed above a preferred embodiment would include electronic input of the passenger's ID data. In this embodiment, the system would include a barcode/magnetic stripe reader (or comparable electronic data reading device). The passenger would be required to provide a government-issued photo ID with electronically-encoded identification information (e.g., driver's license), which would then be electronically read, input and verified against the travel management system database. The advantages of this embodiment include its increased speed and error reduction by minimizing manual input by check-in personnel, and electronic verification of the ID's validity by detection of falsified ID.

Concerning improved U.S. national and/or international security interests, the travel management system database can be linked to national or international security databases that will automatically record a passenger's nationality and alert check-in and security personnel of passengers deemed to be “at risk” in terms of security interests.

Concerning improved passenger traffic flow, the system can be equipped at the check-in or ticketing points with a printing component suitable for imprinting the RFID appliances with visible indicia. In effect, the RFID appliance attached to the passenger becomes the ticket, said printable indicia can supply key travel itineraries in a visibly readable form for the passenger's reference and, for airline and security personnel, as a cross-checking security reference.

Concerning improved identification capabilities, the system can be equipped with a biosensor component, either at the check-in/baggage pick-up and key cross-check points, or in the RFID appliance attached to the passenger; said biosensor would supply unique identifying information such as fingerprint. As a further improvement on this embodiment, related to national or international security concerns, if fingerprinting biosensors are employed, the data taken from the passenger can be cross-referenced to the (inter)national security database.

Concerning improved identification capabilities, the system can be equipped with a photographic component at the check-in point; a digital camera would capture a passenger's photograph and it would be input to the database. In alternate embodiments:
indication of the photograph would be written to the RFID appliances affixed to the passenger and his baggage: upon scanning the RFID appliances the reading unit will tap into the database and display the passenger's photograph;
photographic data will be written directly to the RFID appliances affixed to the passenger and (optionally) his baggage: upon scanning the RFID appliances the reading unit will tap into the database and display the passenger's photograph;
the passenger's photograph will be printed on the RFID appliance attached to the passenger.

Concerning improved security, the fastener on the RFID appliance can be configured to electronically indicate whether the appliance has been attached to a wearer or baggage and if so, enable circuit functions; if tampered with, the, circuit functions may be disabled, certain data erased, and/or evidence of tampering will be made apparent. In alternate embodiments, this can be used to enable an ALARM to the system.

Concerning improved functionality, the RFID appliance can employ active, semi-active or passive radio frequency identification technology.
Passive technology is embodied in the basic system described above. In this embodiment, activation and access to the data encoded in the RFID appliance is triggered by the reader or reader-writer unit. Read range is limited and is always activated by an outside party, not the appliance itself.
Semi-active RFID technology would employ a battery-powered RFID appliance that is inactive unless certain conditions are met. Upon meeting those conditions—e.g., passenger attempts to remove the appliance while within the travel management system flow—the RFID appliance is activate and broadcasts an alarm or other information as encoded. Broadcast range is largely dependent upon the strength of the battery used. It is still capable of passive RFID read-write characteristics.
Active RFID technology would employ a battery-powered RFID appliance that is always active and broadcasting its encoded data until the battery dies or is removed. Broadcast range is largely dependent upon the strength of the battery used. In this embodiment, read and read-write contacts can be at relatively long distances from the RFID appliance—airline/security personnel contact with passengers and their baggage can be less intrusive and passenger traffic flows more freely.

Concerning RFID appliances, the invention will employ a combination of affixable appliances, to best fit the combined needs of security, non-transferability, reliability and budget. A key characteristic of a combination is that they are for temporary application and that the basic appliance to be worn by the passenger is a tamper-resistant band. However, the band can be employed in several configurations.

The following patents and pending patent applications owned by the common assignee of this invention include components, systems and processes which can be utilized in connection with the present invention:

(1) ENHANCED IDENTIFCATION APPLIANCE, U.S. application Ser. No. 10/101,219 filed Nov. 19, 1996;

(2) LINKAGE ID SYSTEM, U.S. Pat. No. 5,979,941, priority date Nov. 19, 1996;

(3) SYSTEM & METHOD FOR AUTHORIZING TRANSACTIONS, U.S. application Ser. No. 10/964,562, filed Oct. 12, 2004;

(4) ID WARNING DETECTION APPLIANCE & SYSTEM, U.S. application Ser. No. 10/785,128, filed Feb. 23, 2004;

(5) MULTI-PART FORM HAVING DETACHABLE WRISTBAND, LABELS & CARDS, U.S. application Ser. No. 10/322,320, filed Dec. 17, 2002; and

(6) IDENTIFICATION TAG & TAG SYSTEM, U.S. application Ser. No. 10/722,978, filed Nov. 25, 2003.

The disclosures of these references are incorporated herein by reference.

Although several embodiments have been described in detail for purposes of illustration, various modifications may be made without departing from the scope and spirit of the invention.

What is claimed is:

1. A process for identifying and tracking persons and related articles, comprising the steps of:
registering a person and one or more articles in a coordinated relationship;
storing information concerning the person, the articles and the coordinated relationship in a database;
cross-referencing RFID tags with the information stored in the database;
attaching the cross-referenced RFID tags to the person and at least one of the articles;
reading the RFID tags; and
enabling an alarm if the RFID tags do not match the cross-referenced information stored in the database.

2. The process of claim 1, further including the step of isolating the person and the articles if the RFID tags do not match the cross-referenced information stored in the database.

3. The process of claim 1, further including the step of cross-checking the RFID tags with the cross-referenced information stored in the database concerning the person, the articles and the coordinated relationship.

4. The process of claim 1, wherein the registering step includes the step of inputting identification data about the person via electronic means.

5. The process of claim 4, wherein the electronic means comprises bar codes, magnetic stripes, RFID cards, biometric chips, cameras or sensors.

6. The process of claim 1, wherein the registering, storing, and cross-referencing steps utilize biosensor or photographic equipment.

7. The process of claim 3, wherein the registering, storing, cross-referencing and cross-checking steps utilize biosensor or photographic equipment.

8. The process of claim 1, further comprising the step of printing visible indicia on the RFID tags corresponding to person or article identification data.

9. The process of claim 1, wherein the RFID tags are non-transferable.

10. The process of claim 3, wherein the reading and cross-checking steps are performed at random intervals.

11. The process of claim 1, wherein the RFID tags are active, semi-active, or passive.

12. The process of claim 1, wherein the RFID tags are tamper resistant.

13. The process of claim 12, further comprising the step of enabling an alarm if the RFID tags are tampered with or removed from the person or articles.

14. The process of claim 1, wherein the coordinated relationship cross-identifies the person or articles with a group of persons.

15. The process of claim 14, further comprising the step of enabling an alarm if the person or articles are separated from the group of persons.

16. The process of claim 15, further comprising the step of isolating the person or the articles if the person or articles are separated from the group of persons.

17. The process of claim 1, wherein the RFID tags comprise wristbands, stickers, labels, cards, badges or combinations thereof.

18. The process of claim 1, wherein the database is linked with national identity, national security, or law enforcement agency databases.

19. A process for identifying and tracking passengers and baggage in relation to a transportation vehicle, comprising the steps of:
registering a passenger and one or more articles of baggage in a coordinated relationship to a transportation vehicle;
storing information concerning the passenger, the articles of baggage, and the coordinated relationship to the transportation vehicle in a database;
cross-referencing RFID tags with the information stored in the database;
attaching the cross-referenced RFID tags to the passenger and at least one of the articles of baggage;
reading the RFID tags; and
enabling an alarm if the RFID tags do not match the cross-referenced information stored in the database.

20. The process of claim 19, further comprising the step of cross-checking the RFID tags with the cross-referenced information stored in the database concerning the passenger, the articles of baggage, and the coordinated relationship to the transportation vehicle.

21. The process of claim 19, further comprising the step of isolating the passenger and the articles of baggage, from the transportation vehicle, other passengers, and other articles of baggage, if the RFID tags do not match the cross-referenced information stored in the database.

22. The process of claim 19, further comprising the steps of moving the passenger and the articles of baggage through a transportation terminal to a point of embarkation and loading the passenger and the articles of baggage onto the transportation vehicle at the point of embarkation.

23. The process of claim 20, wherein the reading and cross-checking steps are performed at random intervals.

24. The process of claim 22, wherein the reading step is performed at random intervals in the transportation terminal between the attaching step and the loading step.

25. The process of claim 24, further comprising the step of enabling an alarm and isolating the passenger and the articles of baggage, from the transportation vehicle, other passengers, and other articles of baggage, in the transportation terminal if the RFID tags do not match the cross-referenced information stored in the database.

26. The process of claim 22, further comprising the steps of:
unloading the passenger and the articles of baggage from the transportation vehicle at the point of disembarkation;
reading the RFID tags during the unloading step;
cross-checking the RFID tags with the cross-referenced information stored in the database concerning the passenger, the articles of baggage, and the coordinated relationship to the transportation vehicle; and
enabling an alarm and isolating the passenger and the articles of baggage at the point of disembarkation, from the transportation vehicle, other passengers, and other articles of baggage, if the RFID tags do not match the cross-referenced information stored in the database.

27. The process of claim 19, wherein the registering step includes the step of inputting identification data about the passenger via electronic means.

28. The process of claim 27, wherein the electronic means comprises bar codes, magnetic stripes, RFID cards, biometric chips, cameras or sensors.

29. The process of claim 19, wherein the registering, storing, and cross-referencing steps utilize biosensor or photographic equipment.

30. The process of claim 20, wherein the registering, storing, cross-referencing and cross-checking steps utilize biosensor or photographic equipment.

31. The process of claim 19, further comprising the step of printing visible indicia on the RFID tags corresponding to passenger or articles of baggage identification data or a passenger travel itinerary.

32. The process of claim 19, wherein the RFID tags are non-transferable.

33. The process of claim 19, wherein the RFID tags are active, semi-active, or passive.

34. The process of claim 19, wherein the RFID tags are tamper resistant.

35. The process of claim 34, further comprising the step of enabling an alarm if the RFID tags are tampered with or removed from the person or articles of baggage.

36. The process of claim 19, wherein the coordinated relationship cross-identifies the passenger or articles of baggage with a group of passengers.

37. The process of claim 36, further comprising the step of enabling an alarm if the passenger or articles of baggage are separated from the group of passengers.

38. The process of claim 37, further comprising the step of isolating the passenger or the articles of baggage if the passenger or articles of baggage are separated from the group of passengers.

39. The process of claim 19, wherein the RFID tags comprise wristbands, stickers, labels, cards, or combinations thereof.

40. The process of claim 19, wherein the database is linked with national identity, national security, or law enforcement agency databases.

41. A travel management system for securely identifying and tracking passengers and articles of baggage in relation to a transportation vehicle in a transportation terminal, comprising:
a travel management system database connected to one or more transportation terminals having embarkation and disembarkation points;
at least one RFID reader/writer device in communication with the travel management system database; and
at least one RFID tag in communication with the RFID reader/writer device.

42. The system of claim 41, wherein the RFID tag is affixed to a passenger.

43. The system of claim 41, wherein the RFID tag is affixed to an article of baggage.

44. The system of claim 41, wherein the travel management system database is connected with national identity, national security, or law enforcement agency databases.

45. The system of claim 41, wherein the RFID tags comprise wristbands, stickers, labels, cards, badges or combinations thereof.

46. The system of claim 41, further comprising biosensor or photographic equipment in communication with the travel management system database.

47. The system of claim 41, further comprising visible indicia printed on the RFID tag corresponding to passenger or baggage identification data.
